(19) United States
(12) Patent Application Publication
(10) Pub. No.: US 2025/0371217 A1
(43) Pub. Date: Dec. 4, 2025

(54) METHOD FOR DESIGNING ABRASIVE WATER JET-DISC CUTTER COMBINED ROCK-BREAKING CUTTER HEAD, SYSTEM THEREFOR, CUTTER HEAD AND TUNNEL BORING MACHINE

(71) Applicant: SHANDONG UNIVERSITY, Jinan (CN)

(72) Inventors: Bin LIU, Jinan (CN); Biao Li, Jinan (CN); Bo Zhang, Jinan (CN); Mengmeng Hu, Jinan (CN); Chuang Huang, Jinan (CN); Hu Yu, Jinan (CN); Tongyuan Liu, Jinan (CN); Liuqi Gu, Jinan (CN); Xinjie Huang, Jinan (CN); Bin Xu, Jinan (CN)

(73) Assignee: SHANDONG UNIVERSITY, Jinan (CN)

(21) Appl. No.: 19/301,627

(22) Filed: Aug. 15, 2025

Related U.S. Application Data
(63) Continuation of application No. PCT/CN2023/128700, filed on Oct. 31, 2023.

(30) Foreign Application Priority Data
Feb. 15, 2023 (CN) 2023101390013

(51) Int. Cl. G06F 30/20; G06F 30/17; G06F 119/02; G06F 119/14

(52) U.S. Cl. CPC G06F 30/20; G06F 30/17; G06F 2119/02; G06F 2119/14

(57) ABSTRACT

The present invention provides a method for designing an abrasive water jet-disc cutter combined rock-breaking cutter head, a system therefor, a cutter head and a tunnel boring machine (TBM), wherein the key technology of designing the abrasive water jet-disc cutter combined rock-breaking cutter head of the TBM are provided from the aspects of determining a combined rock-breaking combination mode, configuration of cutter operation parameters and optimization of the combined cutter head; the performance of the abrasive water jet-disc cutter combined rock-breaking cutter head manufactured according to the optimized layout parameters is improved; and a new idea is provided for the development and application of a full-section rock tunneling machine in the field of underground engineering.

### CROSS-REFERENCE TO RELATED APPLICATIONS

The present invention claims priority benefits to Chinese Patent Application No. 202310139001.3, entitled “ABRASIVE WATER JET-DISC CUTTER COMBINED ROCK-BREAKING CUTTERHEAD DESIGN METHOD, SYSTEM, CUTTERHEAD, AND TBM”, filed on Feb. 15, 2023, with China National Intellectual Property Administration, the entire contents of which are incorporated herein by reference.

### TECHNICAL FIELD

The present invention belongs to the technical field of tunnel construction and relates to a method for designing an abrasive water jet-disc cutter combined rock-breaking cutter head, a system therefor, a cutter head and a tunnel boring machine.

### BACKGROUND

The statements in this section merely provide background information related to the present invention and are not necessarily prior art.

Tunnel Boring Machine (TBM) is widely used in rock tunnel construction of highway, railway and water conservancy because of its advantages of high quality, small disturbance of surrounding rock and high safety and efficiency. However, when encountering extremely hard rock with high confining pressure and high abrasiveness, the rock-breaking ability of TBM is greatly reduced, and is manifested in the reduction of penetration depth and the abnormal damage of cutter head, seriously affecting the construction efficiency. Under this background, water-jet combined rock-breaking technology is proposed and considered as one of the most effective ways to improve the rock-breaking ability of TBM. Compared with other kinds of water jet, abrasive water jet has stronger rock-breaking ability. If it is successfully carried on TBM, it is expected to completely solve the problem of low tunneling performance of the TBM under extreme formation conditions.

The abrasive water jet-disc cutter combined cutter head is the most important part of new type TBM, the cutter head working environment is bad and the load condition is complex in the construction process, whether its design is reasonable or not directly determines the working performance of water-jet TBM. However, considering that abrasive water jet-disc cutter combined cutter head is compatible with water jet rock-breaking system and disc cutter rock-breaking system on TBM, there is a great difference between the design of the traditional mechanical cutter head, thus the existing design method of cutter head is no longer applicable.

### SUMMARY

In order to solve the above-mentioned problems, the present invention provide a method for designing an abrasive water jet-disc cutter combined rock-breaking cutter head, a system therefor, a cutter head and a TBM, improving the performance of the abrasive water jet-disc cutter combined rock-breaking cutter head from the aspects of determining a combined rock-breaking combination mode, configuring cutter operation parameters and optimizing the combined cutter head, the operation quality is ensured, and a new idea is provided for the fields of full-section rock excavation and underground engineering.

According to some embodiments, the present invention adopts the following technical solutions.

A method for designing an abrasive water jet-disc cutter combined rock-breaking cutter head, comprising the following steps:
determining key parameters of cutting performance of abrasive water jet by taking a cutting depth of the abrasive water jet cutting rocks as a target, and determining dominant ranges of the key parameters of the abrasive water jet;
classifying rock-breaking modes of abrasive water jet-disc cutter combined, and determining dominant ranges of rock-breaking parameters under different rock-breaking modes by considering a rock-breaking force and a rock-breaking energy dissipation of cutters;
establishing a layout principle of a combined cutter head according to the dominant ranges of the key parameters and the dominant ranges of the rock-breaking parameters, and by considering a coordination and an installation distribution characteristics of multi-water jet cutter and multi-disc cutter combined rock-breaking on the combined cutter head; and
establishing optimization objective functions according to the layout principle of the combined cutter head, solving the optimization objective functions according to a preset optimization sequence under constraint conditions, and then obtaining a final design scheme of the combined cutter head.

As an alternative implementation mode, the key parameters comprise a traverse velocity vₛ, a pump pressure P, a target distance h, cutting times T, a nozzle diameter d, and an abrasive flow rate mₐ.

As an alternative implementation mode, based on an importance of an influence of process parameters of the abrasive water jet cutting rock on the cutting depth, the key parameters are ranked as follows:
the traverse velocity vₛ>the cutting times T>the nozzle diameter d>the pump pressure P>the target distance h.

As an alternative implementation mode, the dominant ranges of the key parameters of the abrasive water jet comprises: the pump pressure P is of 280-350 MPa, the traverse velocity vₛ is of 0-15 m/min, the target distance h is of 15-40 mm, the abrasive flow rate mₐ is of 1150-1250 g/min, the nozzle diameter d is of 0.33-0.5 mm, and the cutting times T is of 1-3.

As an alternative implementation mode, the abrasive water jet-disc cutter combined rock-breaking mode comprises: a same-trajectory rock-breaking mode and a different-trajectory rock-breaking mode, wherein the same-trajectory rock-breaking mode indicates that a cutting trajectory of the abrasive water jet on the combined cutter head overlaps with a cutting trajectory of the disc cutter, and the different-trajectory rock-breaking mode indicates that the cutting trajectories of the abrasive water jet and the disc cutter are different.

As an alternative implementation mode, by considering the rock-breaking force and rock-breaking energy dissipation of the cutters, a specific process of determining the dominant ranges of the rock-breaking parameters under the different rock-breaking modes comprises: respectively carrying out a performance evaluation of combined rock-breaking under multi-parameter conditions for the different rock-breaking modes; establishing a combined rock-breaking cutter mechanical model and selection criterions of a combined rock-breaking dominant mode with the rock-breaking force as evaluation indexes; and, determining dominant rock-breaking parameters of each the rock-breaking modes with the rock-breaking force and the rock-breaking energy dissipation as evaluation indexes.

As a further limitation, the combined rock-breaking cutter mechanical model is:

$$\begin{matrix}{F}_{n}^{C M} = {F}_{t} cos ( \frac{ϕ}{2} ) = C {\frac{ϕ R W}{1 + ψ} [ \frac{S {σ}_{c}^{2} {σ}_{t}}{ϕ \sqrt{R W}} ]}^{\frac{1}{3}} cos ( \frac{ϕ}{2} ) , \\ {F}_{r}^{C M} = {F}_{t} sin ( \frac{ϕ}{2} ) = C {\frac{ϕ R W}{1 + ψ} [ \frac{S {σ}_{c}^{2} {σ}_{t}}{ϕ \sqrt{R W}} ]}^{\frac{1}{3}} sin ( \frac{ϕ}{2} ) , \\ \\ \{ \begin{matrix}{F}_{n}^{S M} = [ {a}_{1} {e}^{- {b}_{1} H / {P}_{p e n e t r a t i o n}} / {c}_{1} ] {F}_{n}^{C M} \\ {F}_{r}^{S M} = [ {a}_{2} {e}^{- {b}_{2} H / {P}_{p e n e t r a t i o n}} / {c}_{2} ] {F}_{r}^{C M} \\ {F}_{n}^{D M} = [ {a}_{1} {e}^{- {b}_{1} H / {P}_{p e n e t r a t i o n}} / {c}_{1} ] {F}_{n}^{CM} \\ {F}_{r}^{D M} = [ {a}_{2} {e}^{- {b}_{2} H / {P}_{p e n e t r a t i o n}} / {c}_{2} ] {F}_{r}^{C M}\end{matrix} ,\end{matrix}$$

wherein,

$${F}_{n}^{C M} and {F}_{r}^{C M}$$

are the rock-breaking force of the disc cutter in complete cutting mode calculated by a CSM model (C indicates “Critical Path Method”, S indicates “Schedule Quantification Method”, and M indicates “Monte Carlo Simulation”); Fₙ and Fᵣ are a normal force and a rolling force of the disc cutter in the combined rock-breaking, Pₚₑₙₑₜᵣₐₜᵢₒₙ is penetration, H is kerf depth, Fₜ is resultant force of the disc cutter, R is radius of disc cutter, W is edge width of the disc cutter, ψ is pressure distribution coefficient of cutting edge, which decreases with the increase of edge width, ϕ is a contact angle between rock and the disc cutter, P⁰ is basic pressure, σ_{c} is uniaxial compressive strength of the rock, σₜ is tensile strength of the rock, S is a cutter spacing distance between the cutters, C is constant, aᵢ and cᵢ are coefficients respectively, wherein i=1 or 2.

As a further limitation, the selection criterions of the combined rock-breaking dominant mode are:
when the penetration of the disc cutter<the kerf depth, the same-trajectory rock-breaking mode is optimal;
when the penetration of the disc cutter≥the kerf depth, the different-trajectory rock-breaking mode is optimal.

As a further limitation, the dominant rock-breaking parameters comprise: the cutter spacing distance, the penetration of the disc cutter and the kerf depth.

As an alternative implementation mode, the layout principle on the combined cutter head comprises a plurality of requirements, such as requirement of cutting depth consistency of the abrasive water jet, requirement of geometric installation space requirement of the water jet, requirement of installation protection of the water jet, requirement of mechanical balance of the combined cutter head, requirement of optimal rock-breaking efficiency, requirement of centroid distribution of the disc cutter, and requirement of rock-breaking amount approaching of the disc cutter.

As an alternative implementation mode, the optimization objective functions comprise a cutter head radial resultant force, an overturning moment, a cutter head centroid distribution and a rock-breaking amount difference of single cutter.

As an alternative implementation mode, the constraint conditions comprise several of optimal rock-breaking efficiency, optimal combination mode of the water jet and the disc cutter, single-cutter bearing capacity and position non-interference requirement.

As an alternative implementation mode, the preset optimization sequence is a cutter head overturning moment, a radial load, a cutter head centroid distribution and a rock-breaking amount difference.

A system for designing an abrasive water jet-disc cutter combined rock-breaking cutter head, comprising:
an abrasive water jet analysis module, configured to determine key parameters of cutting performance of abrasive water jet and determine dominant ranges of the key parameters of the abrasive water jet with a cutting depth of the abrasive water jet cutting rock as a target;
a combined rock-breaking analysis module, configured to classify abrasive water jet-disc cutter combined rock-breaking modes, and determine dominant ranges of rock-breaking parameters under different modes by considering a rock-breaking force and a rock-breaking energy dissipation of cutters;
a cutter head layout principle determining module, configured to establish a cutter head layout principle by comprehensively considering coordination and installation distribution characteristics of a combined cutter head with multi-water jet and multi-disc cutter combined rock-breaking according to the dominant ranges of the key parameters and the dominant ranges of the rock-breaking parameters; and
an optimization solution module, configured to establish optimization objective functions according to the cutter head layout principle, and solve the optimization objective functions according to a predetermined optimization sequence under constraint conditions to obtain a final design scheme of the combined cutter head.

A cutter head, obtained by carrying out the above method, wherein:
determining key parameters of cutting performance of abrasive water jet by taking a cutting depth of the abrasive water jet cutting rocks as a target, and determining dominant ranges of the key parameters of the abrasive water jet;
classifying rock-breaking modes of abrasive water jet-disc cutter combined, and determining dominant ranges of rock-breaking parameters under different rock-breaking modes by considering a rock-breaking force and a rock-breaking energy dissipation of cutters;
establishing layout principle of a combined cutter head according to the dominant ranges of the key parameters and the dominant ranges of the rock-breaking parameters, and by considering a coordination and an installation distribution characteristics of multi-water jet cutter and multi-disc cutter combined rock-breaking on the combined cutter head;
establishing optimization objective functions according to the layout principle of the combined cutter head, solving the optimization objective functions according to a preset optimization sequence under constraint conditions, and then obtaining optimized position parameters of the multi-water jet and the multi-disc cutter on a cutter head;
installing multiple water jets and multiple disc cutters at corresponding positions on the cutter head according to the obtained position parameters so as to obtain the combined cutter head.

A TBM, comprising a combined cutter head described above.

Compared with the prior art, the present invention has the beneficial effects that:

According to the present invention, a complete set of key technologies for designing the abrasive water jet-disc cutter combined cutter head are established, and specifically comprise a design principle, a design basis and a design optimization method of the combined cutter head, so that the difficult problem that the design process of the combined cutter head lacks scientific guidance is solved, and the auxiliary effect of the abrasive water jet on mechanical rock-breaking is facilitated to be fully exerted.

According to the present invention, the provided dominant rock-breaking parameters of the abrasive water jet and the ranges thereof, can increase the penetration capability of a disc cutter into rocks, and can be used for guiding stone processing to obtain specified target depths.

According to the present invention, the established mode selection basis and the combined rock-breaking dominant parameters, can improve the combined rock-breaking efficiency of the abrasive water jet and the disc cutter, and reduce the construction cost.

According to the present invention, the established mechanical model of the abrasive water jet-disc cutter combined rock-breaking, can be used for guiding the control of combined rock-breaking parameters, improving the auxiliary rock-breaking effect to the maximum extent and reducing excessive energy loss.

According to the present invention, the established combined cutter head optimization method and the constraint conditions, can obviously improve the overall mechanical performance of the cutter head, and effectively reduce the possibility of abnormal damage of the main bearing and the cutter head caused by unbalanced action.

According to the present invention, the established combined cutter head design method may be applicable to the design of various cutter heads such as random shape, Union Jack pattern shape, spiral line shape and the like, can improve the overall rock-breaking performance of the multi-type cutter head, and accelerate the development of the abrasive water jet assisted rock-breaking tunneling machine technology.

### BRIEF DESCRIPTION OF THE DRAWINGS

The accompanying drawings constituting a part of the present invention are used to provide a further understanding of the present invention. The exemplary examples of the present invention and descriptions thereof are used to explain the present invention, and do not constitute an improper limitation of the present invention.

FIG. 1 is a schematic diagram of a design flow of the present invention.

FIG. 2 is a flow chart of an optimization method of abrasive water jet cutting rock performance.

FIG. 3A shows a relationship between a pump pressure and a kerf depth in the abrasive waterjet cutting rock performance.

FIG. 3B shows a relationship between the pump pressure and a pump pressure shearability index in the abrasive waterjet cutting rock performance.

FIG. 3C shows a relationship between the pump pressure and a pump pressure energy dissipation index in the abrasive water jet cutting rock performance.

FIG. 3D shows a relationship between a traverse velocity and the kerf depth in the abrasive waterjet cutting rock performance.

FIG. 3E shows a relationship between the traverse velocity and a traverse velocity shearability index in the abrasive waterjet cutting rock performance.

FIG. 3F shows a relationship between the traverse velocity and a traverse velocity energy dissipation index in the abrasive waterjet cutting rock performance.

FIG. 3G shows a relationship between target distance and the kerf depth in the abrasive waterjet cutting rock performance.

FIG. 3H shows a relationship between the target distance and a target distance shearability index in the abrasive waterjet cutting rock performance.

FIG. 3I shows a relationship between the target distance and a target distance energy dissipation index in the abrasive waterjet cutting rock performance.

FIG. 3J shows a relationship between an abrasive flow rate and the kerf depth in the abrasive waterjet cutting rock performance.

FIG. 3K shows a relationship between the abrasive flow rate and an abrasive flow rate shearability index in the abrasive waterjet cutting rock performance.

FIG. 3L shows a relationship between the abrasive flow rate and an abrasive flow energy dissipation index in the abrasive waterjet cutting rock performance.

FIG. 3M shows a relationship between a nozzle diameter and the kerf depth in the abrasive waterjet cutting rock performance.

FIG. 3N shows a relationship between the nozzle diameter and a nozzle diameter shearability index in the abrasive waterjet cutting rock performance.

FIG. 3O shows a relationship between the nozzle diameter and a nozzle diameter energy dissipation index in the abrasive waterjet cutting rock performance.

FIG. 3P shows a relationship between cutting times and the kerf depth in the abrasive waterjet cutting rock performance.

FIG. 3Q shows a relationship between the cutting times and a cutting times shearability index in the abrasive waterjet cutting rock performance.

FIG. 3R shows a relationship between the cutting times and a cutting times energy dissipation index in the abrasive waterjet cutting rock performance.

FIG. 4A is a schematic diagram of a correlation between rock density and the kerf depth of the abrasive water jet.

FIG. 4B is a schematic diagram of a correlation between rock micro hardness and the kerf depth of the abrasive water jet.

FIG. 4C is a schematic diagram of a correlation between rock elastic modulus and the kerf depth of the abrasive water jet.

FIG. 4D is a schematic diagram of a correlation between rock wave velocity and the kerf depth of the abrasive water jet.

FIG. 4E is a schematic diagram of a correlation between rock compressive strength and the kerf depth of the abrasive water jet.

FIG. 4F is a schematic diagram of a correlation between rock tensile strength and the kerf depth of the abrasive water jet.

FIG. 5 is a graph of prediction result and average error of cutting depth of the abrasive water jet cutting rock.

FIG. 6A is a schematic diagram of a complete rock-breaking combination mode of an abrasive water jet-disc cutter combined cutter.

FIG. 6B is a schematic diagram of a same-trajectory rock-breaking combination mode of the abrasive water jet-disc cutter combined cutter.

FIG. 6C is a schematic diagram of a different-trajectory rock-breaking combination mode of the abrasive water jet-disc cutter combined cutter.

FIG. 7A is a schematic diagram of a position and force model of a disc cutter on a cutter head.

FIG. 7B is a schematic diagram of the force model of the disc cutter in Section A-A of FIG. 7A.

FIG. 7C is a schematic diagram of the force model of the disc cutter in Section B-B of FIG. 7A.

FIG. 8 is a schematic diagram of a process flow of genetic algorithm solution for cutter head optimization.

FIG. 9 is a schematic diagram of an optimization result of a random-shaped cutter head.

### DETAILED DESCRIPTION

The present invention will now be further described with reference to the accompanying drawings and examples.

It should be pointed out that the following detailed descriptions are all illustrative and are intended to provide further descriptions of the present invention. Unless otherwise specified, all technical and scientific terms used in the present invention have the same meanings as those usually understood by a person of ordinary skill in the art to which the present invention belongs.

It should be noted that the terms used herein are merely used for describing specific implementations, and are not intended to limit exemplary implementations of the present invention. As used herein, the singular form is also intended to include the plural form unless the context clearly dictates otherwise. In addition, it should further be understood that, terms “comprise/comprising” and/or “include/including” used in this specification indicate that there are features, steps, operations, devices, components, and/or combinations thereof.

### Example 1

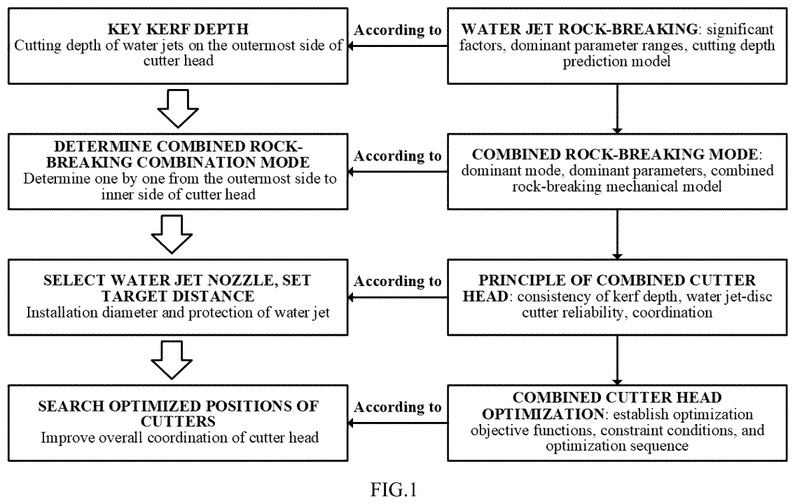

The present invention provides a method for designing of an abrasive water jet-disc cutter combined rock-breaking cutter head on a TBM, as shown in FIG. 1, the main design steps are as follows:
S1: determining key parameters of cutting performance of abrasive water jet by taking a cutting depth of the abrasive water jet cutting rocks as a target, and determining dominant ranges of the key parameters of the abrasive water jet;
S2: establishing selection criterions of combined high-efficiency rock-breaking combination mode, dominant rock-breaking parameters and combined rock-breaking mechanical model based on abrasive water jet-cutter joint rock-breaking tests, forming combined rock-breaking basic basis by synthesizing S1 and S2, to support a layout design of multi-cutter in a cutter head;
S3: establishing a design principle of a combined cutter head by considering a collaborative rock-breaking requirement of a multi-cutter combined rock-breaking system, further establishing a complete set of key technologies and processes for an optimization layout design of the combined cutter head, so as to realize a scientific design of a new-type abrasive water jet-disc cutter combined rock-breaking cutter head.

Firstly, it is to the step that determining key parameters of cutting performance of abrasive water jet by taking a cutting depth of the abrasive water jet cutting rocks as a target, and determining dominant ranges of the key parameters of the abrasive water jet.

In this step, different tests may be conducted to determine the key parameters affecting the abrasive water jet cutting rock performance by different types of rock, and the dominant ranges of the key parameters for. Test methods and analytical methods can be used in the existing technology.

The present invention also provides an improved method for determining the key parameters that affect the abrasive waterjet cutting rock performance and the dominant ranges thereof. Details are as follows:

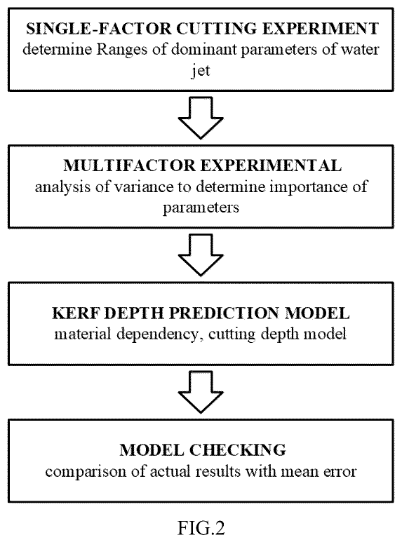

As shown in FIG. 2, determining key parameters of cutting performance of abrasive water jet by taking a cutting depth of the abrasive water jet cutting rocks as a target, and determining dominant ranges of the key parameters of the abrasive water jet, comprising the main steps are as follows:
S21: selecting multiple groups of process parameters that have greater influence on the cutting depth of the abrasive water jet cutting super-hard rock as variables, carrying out single-factor abrasive water jet cutting super-hard rock experiments, and according to the experimental results and engineering construction requirements, deeply analyzing the key parameters that significantly affect the cutting performance of the abrasive water jet cutting the super-hard rock and influence rules of each of the parameters on the cutting performance of the abrasive water jet, and selecting the dominant range of the each of the parameters.
S22: based on the dominant range of the each of the parameters determined in S21, designing an experimental scheme with an aid of a response surface experimental design method, taking each influence parameter as a variable and the cutting depth of the abrasive water jet cutting super-hard rock as a response value, carrying out an abrasive water jet cutting super-hard rock experiment, and measuring and obtaining kerf depths generated by cutting the super-hard rock by using each group of parameters in the experimental scheme.
S23: carrying out a variance analysis of each parameter affecting a kerf performance of the abrasive water jet to clarify the sensitivity of the each parameter to the kerf performance of the abrasive water jet.
S24: establishing a cutting depth prediction model of abrasive water jet; carrying out a regression analysis on the cutting depth prediction model by using a nonlinear multiple regression analysis method; inputting the test data in step S22 into the prediction model for multiple iteration processing to obtain a cutting depth prediction model of rock-abrasive water jet, and then verifying the accuracy of the model, and providing the parameter guidance of the water jet for combined rock-breaking.

Selecting rock samples with five kinds of strength, and the physical and mechanical performance parameters of the samples are shown in Table 1; selecting the traverse speed vₛ, pump pressure P, target distance h, nozzle diameter d, cutting times T and abrasive flow rate mₐ as variables to conduct the single-factor cutting experiments, and the values of each factor are shown in Table 2.

The tools used in the test comprise a vernier caliper, a test pad and a steel needle; wherein, after cutting a super-hard rock sample by the abrasive water jet, placing the test pad on a surface of the rock sample, inserting the steel needle into a kerf formed by the water jet cutting, marking a corresponding position of the test pad on the steel needle, measuring a distance between a needle tip of the steel needle and the marked position by using the vernier caliper, and recording the kerf depth of the water jet in the present experiment.

In order to ensure the accuracy of the experimental data of the each sample, the kerf depth is measured at three equally spaced points on the kerf of the abrasive water jet, and then an average of the three kerf depths is taken as a final kerf depth of the experimental sample.

TABLE 1

| | | | Elasticity | Compressive | Tensile | Wave |
|---|---|---|---|---|---|---|
| | Serial | Density/ | Modulus/ | Strength/ | Strength/ | Velocity/ |
| Rock Type | Number(SN) | (g/cm³ ) | (GPa) | (Mpa) | (Mpa) | (m/s) |
| Granite | 1 | 2.589 | 35 | 100 | 6.2 | 3528 |
| Anorthosite | 2 | 2.630 | 38 | 130 | 8.6 | 4380 |
| | 3 | 2.681 | 43 | 160 | 9.7 | 4600 |
| | 4 | 2.612 | 47 | 180 | 14.1 | 3527 |
| | 5 | 3.068 | 65 | 210 | 17.4 | 5657 |

TABLE 2

| | | Level | | | | | | | |
|---|---|---|---|---|---|---|---|---|---|
| Cutting factor | Unit | 1 | 2 | 3 | 4 | 5 | 6 | 7 | 8 |
| Nozzle diameter | mm | 0.33 | 0.5 | 0.68 | | | | | |
| Cutting times | time | 1 | 3 | 5 | 7 | 9 | | | |
| Jet pump-pressure | MPa | 80 | 160 | 240 | 300 | 380 | | | |
| Abrasive flow rate | g/min | 300 | 480 | 660 | 1020 | 1620 | | | |
| Target distance | mm | 20 | 40 | 60 | 80 | 100 | 120 | | |
| Traverse Velocity | m/min | 0.6 | 2.4 | 4.8 | 6 | 9 | 12 | 21 | 30 |

The shearability index and the energy dissipation index are selected to reflect the performance of abrasive water jet cutting super-hard rock. Wherein, the shearability index indicates the kerf depth corresponding to the unit variable (as shown by Equation 1), and the energy dissipation index is the energy consumed by the abrasive water jet cutting an unit depth (as shown by Equation 2). The shearability index and energy dissipation index are in the following forms:

$${CI}_{P} = \frac{H}{P} , {CI}_{{v}_{s}} = \frac{H}{{v}_{s}} , {CI}_{h} = \frac{H}{h} , {CI}_{T} = \frac{H}{T} , {CI}_{d} = \frac{H}{d} , {CI}_{{m}_{a}} = \frac{H}{{m}_{a}} , \qquad ( 1 )$$

$${v}_{water} = 44.7 \sqrt{P} , E = \frac{1}{2} m {v}_{water}^{2} = \frac{π ρ {R}^{2} {L}_{displacement} {v}_{water}^{3}}{2 {v}_{s}} , EI = \frac{m {v}_{water}^{2}}{2 H} ; \qquad ( 2 )$$

wherein, CIₚ is the pump pressure shearability index, CIᵥ_{ₛ} is the traverse velocity shearability index, CIₕ is the target distance shearability index, CI_{T} is the cutting times shearability index, CI_{d} is the nozzle diameter shearability index, CIₘ_{ₐ} is the abrasive flow rate shearability index, EI is the cutting depth energy dissipation index, E is the energy dissipation, v_{water} is the abrasive water jet flow rate, vₛ is the traverse velocity, P is the pump pressure, T is the cutting times, d is the nozzle diameter, R is the nozzle radius, L_{displacement} is the cutting distance, H is the cutting depth, and h is the target distance.

Substituting the measured kerf depth into the Equation (1) of the shearability index and the Equation (2) of the energy dissipation index to obtain the cutting performance of the each experimental sample; based on the results of the shearability index and the energy dissipation index obtained by the single-factor experiment, analyzing the influence rules of each process parameter on the shearability index and the energy dissipation index; and, combined with the actual construction environment and construction requirements of TBM, determining the dominant range of each factor as follows:
the pump pressure P is of 280-350 MPa, the traverse velocity vₛ is of 0-15 m/min, the cutting target distance h is of 15-40 mm, the abrasive flow rate mₐ is of 1150-1250 g/min, the nozzle diameter d is of 0.33-0.5 mm, and the cutting times T is of 1-3 times.

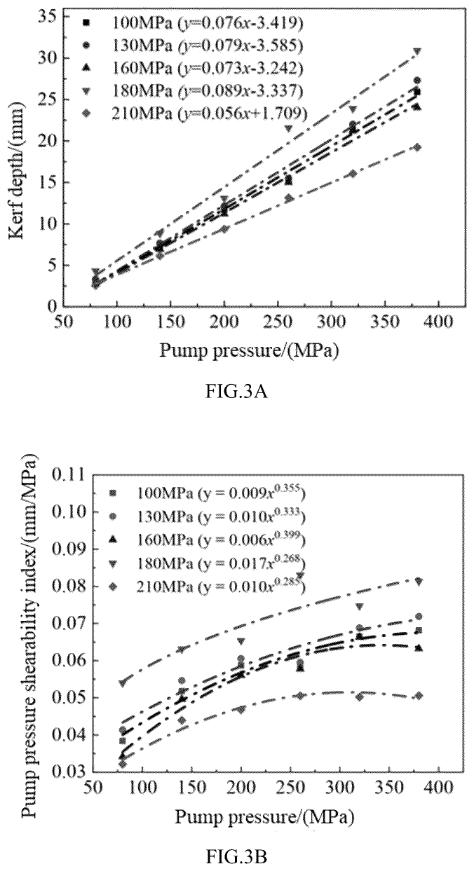

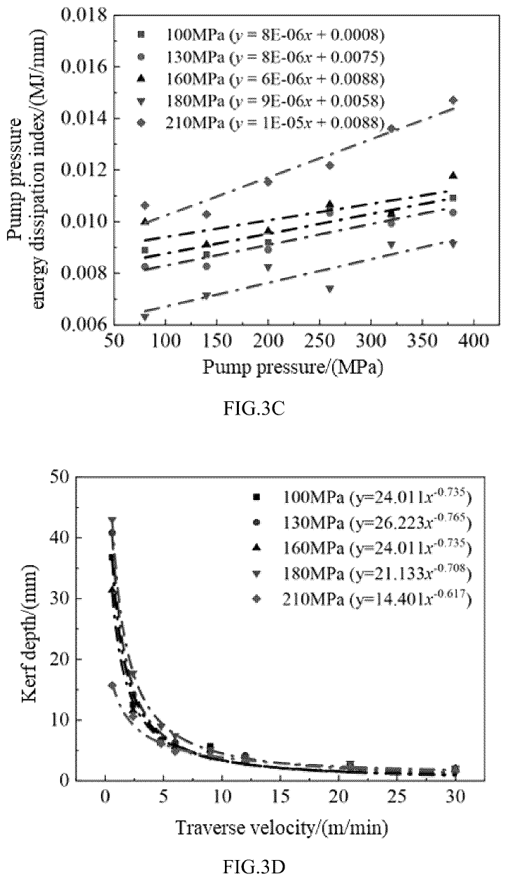

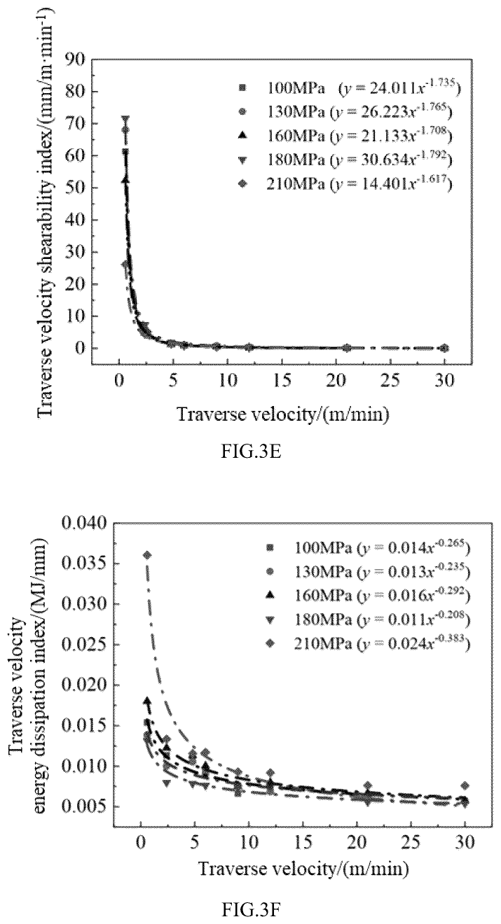

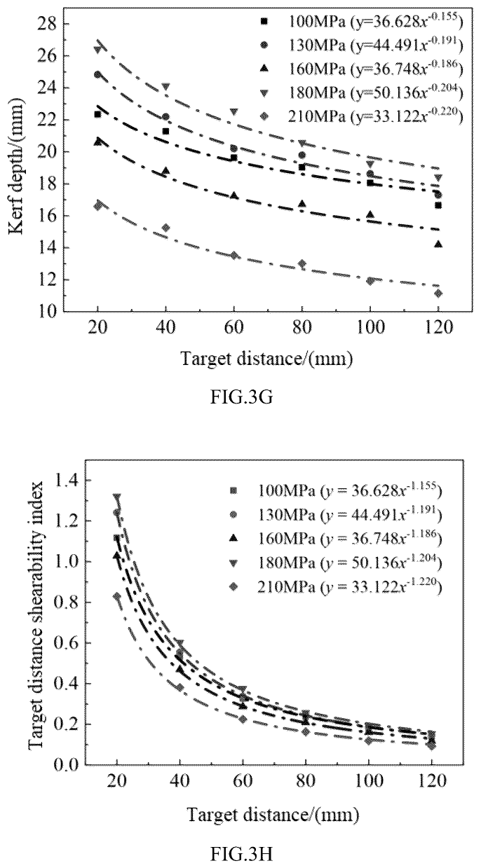

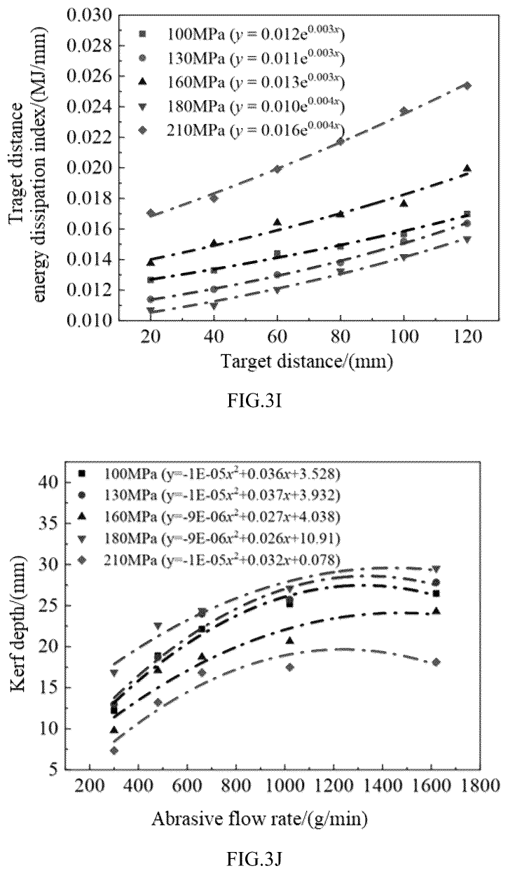

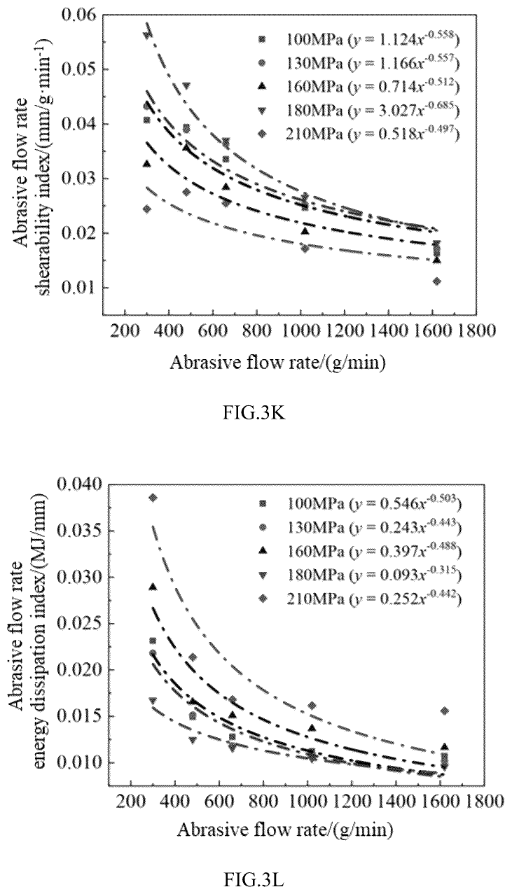

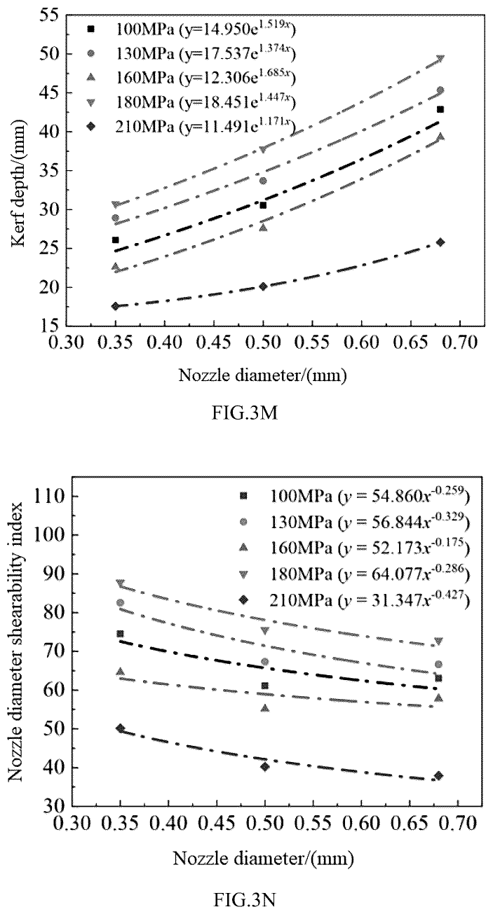

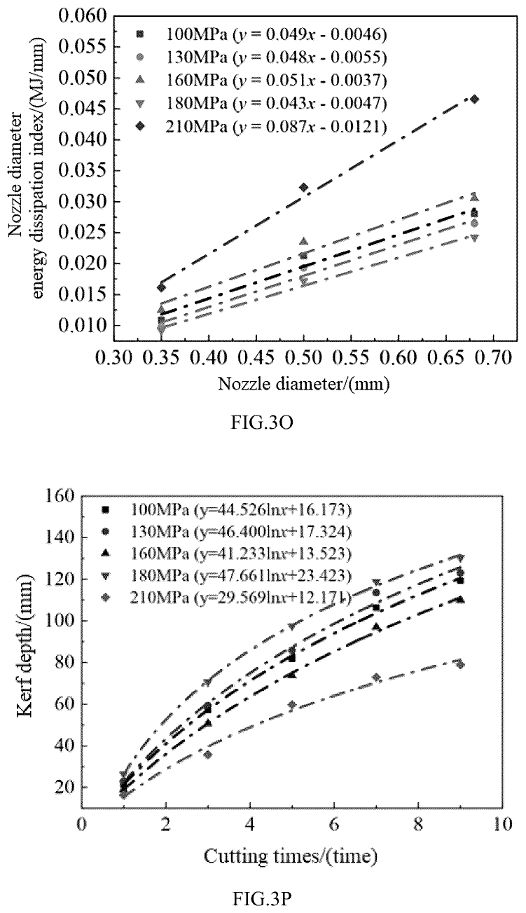

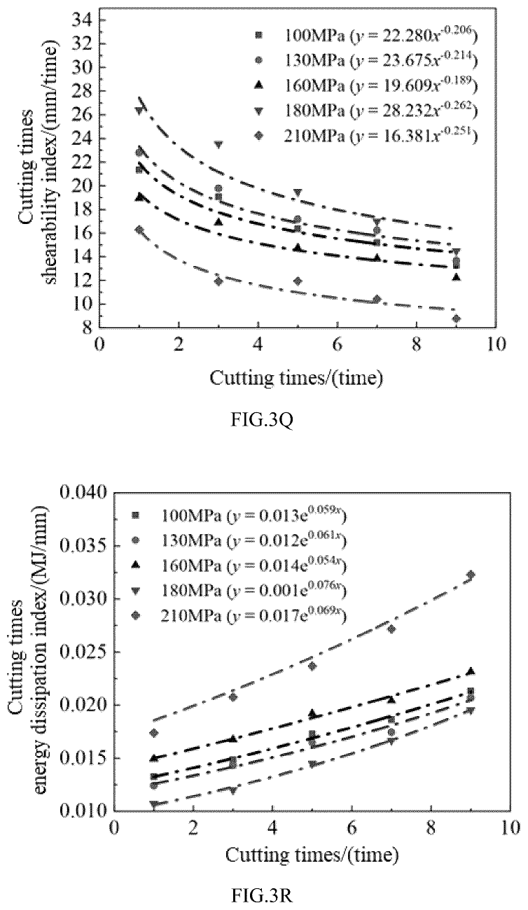

As shown in FIG. 3, taking the abrasive flow rate as an example, it is introduced that a process of the single factor experiment and selection of the dominant ranges of the abrasive water jet parameters:

The cutting experiments of the abrasive water jet at abrasive flow rates of 300 g/min, 480 g/min, 660 g/min, 1020 g/min and 1620 g/min are carried out. In the experiments, the traverse velocity is 1.2 m/min, the pump pressure is 380 MPa, the cutting times is 1 time, the target distance is 20 mm, the nozzle diameter is 0.33 mm, and a cutting length is 0.2 m.

For the five kinds of rocks, with the increase of abrasive flow rate, the kerf depth on the rock increases firstly and then decreases in the form of quadratic function, and a maximum value point of the kerf depth corresponding to an optimum abrasive flow rate is in a range of 1200±50 g/min; the shearability index and the energy dissipation index decrease in the form of power function with the increase of the abrasive flow rate, and the shearability index decreases rapidly when the abrasive flow rate is not in the range of 1200±50 g/min, and then the shearability index decreases slowly. Similarly, there is a similar correspondence between the energy dissipation index and the abrasive flow rate. The above relationship is due to the increase of the abrasive flow rate, the increase of the number of abrasive particles impacting the rock in unit time, and the enhancement of cutting ability, which promotes the deepening of the kerf. However, when the abrasive flow rate increases to a certain value, the abrasive particles easily accumulate at a bottom of the kerf, which results in the failure of subsequent abrasives to effectively contact the rock, the reduction of effective impact times and the reduction of cutting performance. According to the above research, it can be found that when the abrasive flow rate is about 1200±50 g/min, the kerf performance of abrasive water jet cutting will reach the optimum, and the abrasive consumption is relatively small and the better kerf effect can be obtained. Therefore, when abrasive water jet is used to assist TBM in breaking extremely hard rock, it is recommended to adopt the abrasive flow rate of 1200±50 g/min.

Based on the cutting effect of the single factor experiment, the dominant range of each process parameter may be determined. It is found that the traverse velocity, pump pressure, target distance, nozzle diameter and cutting times are the key process parameters of the abrasive water jet cutting the super-hard rock. Taking each process parameter as variable and the kerf depth as response value, the response surface design method-Box-Behnken experimental design method is used to design the experimental scheme. The cutting experiment of the abrasive water jet with five factors and three levels is carried out. The corresponding relationship between response surface experimental parameters and each parameter factor level is shown in Table 3.

TABLE 3

| | | Factor level | | |
|---|---|---|---|---|
| Factor name | Unit | Low | Medium | High |
| Traverse Velocity | m/min | 1.2 | 6.6 | 12 |
| Pump pressure | Mpa | 240 | 300 | 360 |
| Target distance | mm | 20 | 60 | 100 |
| Nozzle diameter | mm | 0.33 | 0.50 | 0.68 |
| Cutting times | time | 1 | 3 | 5 |

According to the response surface method, 46 groups of cutting experiments shall be conducted for the rock of each type, and 230 groups of cutting experiments shall be conducted for the rock of five types in total; and after conducting each group of cutting experiments, the kerf depth of the water jet of the experimental sample shall be measured and obtained. The multi-factor experimental scheme designed by the response surface method and the corresponding cutting depth value are shown in Table 4.

TABLE 4

| | | | | | | Kerf depth/ | | | | |
|---|---|---|---|---|---|---|---|---|---|---|
| | Traverse | Target | Pump | Nozzle | Cutting | (mm) | | | | |
| | velocity/ | distance/ | pressure/ | diameter/ | times/ | 1 | 2 | 3 | 4 | 5 |
| SN | (m/min) | (mm) | (Mpa) | (mm) | (time) | Rock | Rock | Rock | Rock | Rock |
| 1 | 6600 | 100 | 300 | 0.50 | 5 | 21.00 | 18.5 | 19.59 | 19.62 | 10.26 |
| 2 | 6600 | 60 | 300 | 0.50 | 3 | 15.84 | 14.89 | 14.99 | 15.85 | 8.11 |
| 3 | 6600 | 100 | 300 | 0.68 | 3 | 29.48 | 22.64 | 21.27 | 24.88 | 10.71 |
| 4 | 1200 | 20 | 300 | 0.50 | 3 | 64.42 | 70.57 | 68.07 | 73.96 | 39.26 |
| 5 | 6600 | 60 | 300 | 0.68 | 5 | 39.52 | 41.87 | 39.52 | 29.4 | 17.23 |
| 6 | 1200 | 60 | 300 | 0.50 | 1 | 19.81 | 22.32 | 20.06 | 22.87 | 14.38 |
| 7 | 6600 | 60 | 240 | 0.50 | 1 | 5.09 | 5.17 | 4.69 | 6.39 | 3.65 |
| 8 | 6600 | 20 | 300 | 0.50 | 1 | 9.07 | 8.51 | 8.41 | 8.74 | 4.49 |
| 9 | 6600 | 60 | 360 | 0.33 | 3 | 13.52 | 14.5 | 13.33 | 14.74 | 8.55 |
| 10 | 6600 | 20 | 300 | 0.68 | 3 | 30.59 | 26.49 | 28.55 | 31.31 | 14.24 |
| 11 | 1200 | 60 | 300 | 0.50 | 5 | 77.47 | 79.92 | 76.79 | 82.58 | 53.65 |
| 12 | 6600 | 100 | 240 | 0.50 | 3 | 12.46 | 9.71 | 11.05 | 10.31 | 6.74 |
| 13 | 1200 | 60 | 300 | 0.33 | 3 | 47.83 | 48.06 | 47.05 | 49.17 | 29.02 |
| 14 | 12000 | 60 | 360 | 0.50 | 3 | 12.54 | 12.55 | 12.04 | 11.22 | 6.16 |
| 15 | 12000 | 100 | 300 | 0.50 | 3 | 11.02 | 8.68 | 9.76 | 9.15 | 4.75 |
| 16 | 1200 | 60 | 240 | 0.50 | 3 | 46.92 | 46.97 | 46.09 | 47.95 | 30.12 |
| 17 | 6600 | 60 | 300 | 0.50 | 3 | 15.45 | 14.87 | 14.72 | 15.53 | 8.11 |
| 18 | 12000 | 60 | 300 | 0.68 | 3 | 23.12 | 17.13 | 20.53 | 18.81 | 7.04 |
| 19 | 6600 | 60 | 300 | 0.50 | 3 | 15.77 | 14.86 | 14.93 | 15.86 | 8.09 |
| 20 | 6600 | 60 | 300 | 0.50 | 3 | 15.1 | 14.86 | 14.49 | 15.36 | 8.03 |
| 21 | 6600 | 60 | 240 | 0.33 | 3 | 8.7 | 8.8 | 8.27 | 8.97 | 5.3 |
| 22 | 6600 | 60 | 240 | 0.68 | 3 | 17.87 | 17.77 | 16.62 | 17.88 | 9.2 |
| 23 | 12000 | 60 | 300 | 0.33 | 3 | 8.32 | 7.37 | 6.88 | 7.38 | 4.73 |
| 24 | 6600 | 100 | 300 | 0.50 | 1 | 6.63 | 6.98 | 6.30 | 6.61 | 3.06 |
| 25 | 6600 | 60 | 300 | 0.50 | 3 | 15.86 | 14.76 | 14.96 | 15.64 | 8.12 |
| 26 | 6600 | 60 | 240 | 0.50 | 5 | 20.57 | 18.25 | 17.90 | 18.84 | 9.19 |
| 27 | 1200 | 100 | 300 | 0.50 | 3 | 51.62 | 51.65 | 50.73 | 51.17 | 30.94 |
| 28 | 6600 | 20 | 360 | 0.50 | 3 | 25.88 | 21.4 | 22.44 | 22.72 | 12.85 |
| 29 | 12000 | 20 | 300 | 0.50 | 3 | 14.64 | 14.54 | 14.08 | 15.16 | 5.83 |
| 30 | 12000 | 60 | 240 | 0.50 | 3 | 7.01 | 7.34 | 6.67 | 7.98 | 4.36 |
| 31 | 6600 | 20 | 240 | 0.50 | 3 | 17.26 | 15.59 | 15.30 | 16.05 | 8.11 |
| 32 | 12000 | 60 | 300 | 0.50 | 5 | 15.23 | 15.78 | 14.88 | 15.9 | 7.27 |
| 33 | 6600 | 60 | 360 | 0.50 | 1 | 7.75 | 9.36 | 7.82 | 9.16 | 4.68 |
| 34 | 6600 | 60 | 300 | 0.50 | 3 | 15.75 | 14.99 | 14.96 | 15.46 | 8.01 |
| 35 | 6600 | 20 | 300 | 0.50 | 5 | 30.42 | 26.34 | 28.39 | 27.83 | 15.38 |
| 36 | 6600 | 60 | 360 | 0.50 | 5 | 27.89 | 26.84 | 26.88 | 25.27 | 12.51 |
| 37 | 1200 | 60 | 360 | 0.50 | 3 | 61.74 | 59.86 | 60.12 | 64.87 | 35.41 |
| 38 | 6600 | 60 | 300 | 0.33 | 1 | 5.59 | 5.42 | 4.90 | 5.62 | 3.76 |
| 39 | 6600 | 100 | 360 | 0.50 | 3 | 15.89 | 15.77 | 15.31 | 14.95 | 8.46 |
| 40 | 6600 | 100 | 300 | 0.33 | 3 | 11.55 | 10.5 | 10.05 | 10.65 | 6.84 |
| 41 | 6600 | 20 | 300 | 0.33 | 3 | 13.91 | 12.82 | 12.37 | 12.93 | 7.85 |
| 42 | 6600 | 60 | 360 | 0.68 | 3 | 28.25 | 28.83 | 27.78 | 30.84 | 14.28 |
| 43 | 6600 | 60 | 300 | 0.33 | 5 | 16.31 | 16.46 | 15.82 | 16.6 | 9.66 |
| 44 | 12000 | 60 | 300 | 0.50 | 1 | 4.66 | 4.89 | 4.31 | 4.68 | 2.87 |
| 45 | 1200 | 60 | 300 | 0.68 | 3 | 75.15 | 76.57 | 74.49 | 80.05 | 43.31 |
| 46 | 6600 | 60 | 300 | 0.68 | 1 | 11.43 | 7.74 | 9.72 | 10.36 | 5.62 |

Based on the experimental results of multi-factor abrasive water jet cutting, the variance analysis is performed on the experimental data in Table 4, and the sequence of importance of the five process parameters affecting the kerf depth is determined as: traverse velocity, cutting times, nozzle diameter, pump pressure and target distance.

In view of this, in order to improve the cutting ability of the abrasive water jet during TBM construction, the first consideration should be to reduce a rotation speed.

Then, according to the set cutting depth prediction model of the abrasive water jet, by using a nonlinear multiple regression analysis method, a regression analysis is conducted on the cutting depth prediction model. The experimental data is substituted into the model for multiple iterations, and a cutting depth prediction model of rock-abrasive water jet is obtained. When the target cutting depth of the abrasive water jet cutting rock is known, the operation parameters of the abrasive water jet can be calculated reversely and the cutting parameters can be optimized.

The cutting depth prediction model of the abrasive water jet is set as follows:

$$H = {λ}_{0} {v}_{s}^{{λ}_{1}} {h}^{{λ}_{2}} {P}^{{λ}_{3}} {d}^{{λ}_{4}} {T}^{{λ}_{5}} ; \qquad ( 3 )$$

wherein, H is that kerf depth, vₛ is the traverse velocity, P is the pump pressure, h is the target distance, d is the nozzle diameter, T is the cut times, λ₀, λ₁, λ₂, λ₃, λ₄, and λ₅ represent the influence between each parameter and the kerf depth.

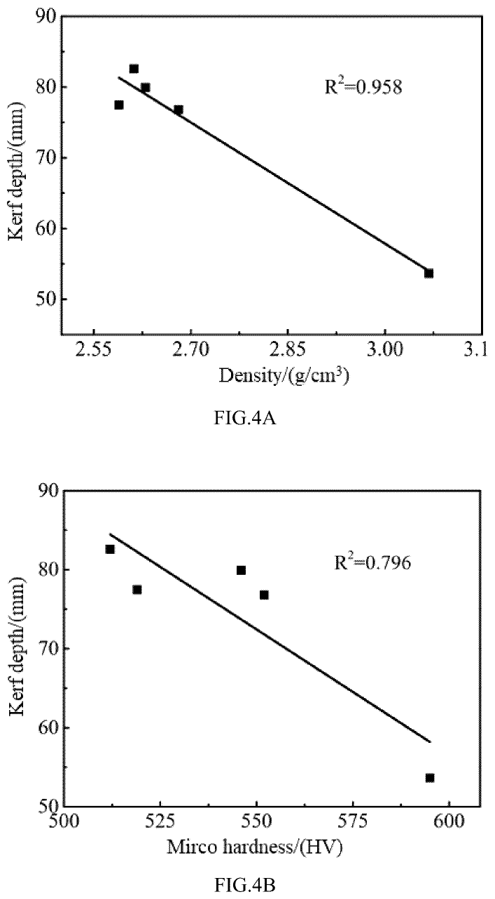

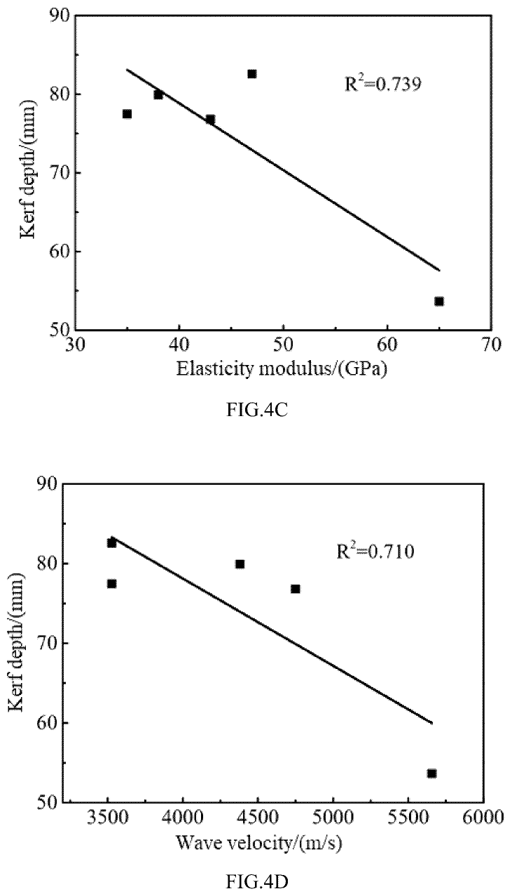

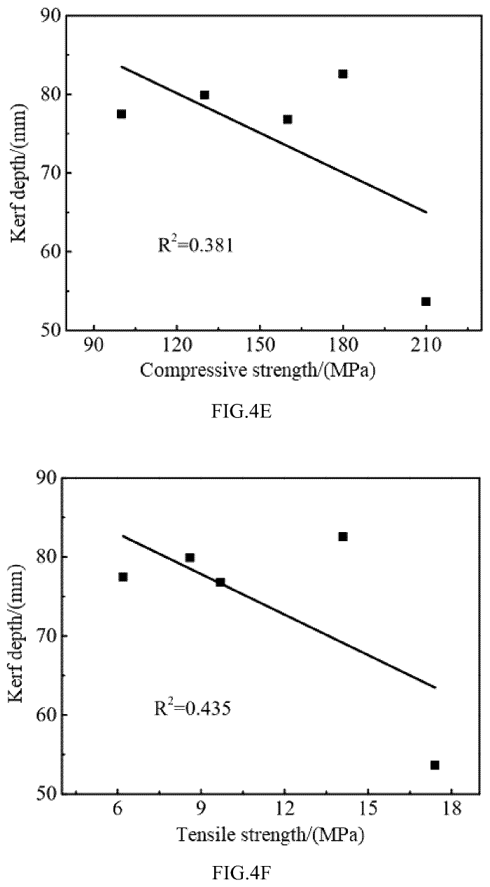

The correlation between six rock material properties such as rock density, micro hardness, compressive strength, tensile strength, elastic modulus and wave velocity and the kerf depth is considered. Selecting the maximum cutting depth under the same constant operating variables in Table 4, the linear correlation between the maximum cutting depth and each rock property is analyzed, as shown in FIG. 4. The results show that the rock density has a significant effect on the kerf depth, the micro hardness, the elastic modulus and the wave velocity have moderate correlation with the kerf depth, but the compressive strength and tensile strength have poor correlation with the kerf depth. Among these six rock material properties, the rock density has the strongest correlation with the kerf depth and is the easiest to obtain in engineering construction, so the rock density of rock material is selected as the characteristic of its inherent properties.

Considering the inherent property of the rock density of rock material, a cutting depth prediction model is established. A nonlinear multiple regression analysis method is selected to perform regression analysis on the cutting depth prediction model. The experiment data in Table 4 of multi-factor experiment results are substituted into the Equation (4) of a model for multiple iterations. The specific cutting depth prediction model of the abrasive water jet corresponding to five kinds of rocks is obtained as shown in the following Equation (4):

$$H = 6845.215 {ρ}^{- 3.328} {v}_{s}^{- 0.717} {h}^{- 0.182} {P}^{0.749} {d}^{0.931} {T}^{0.737} ; \qquad ( 4 )$$

wherein, H is the kerf depth (mm), ρ is the rock density (g/cm³), vₛ is the traverse velocity (m/s), P is the pump pressure (MPa), h is the target distance (m), d is the nozzle diameter (m) and T is the cutting times.

In order to verify the applicability of the model, the rock cutting depths of the five rock materials are predicted and compared with the actual experimental results. The average error of the cutting depths of the five rock materials is about 3.8%, as shown in FIG. 5, which verifies the applicability of the model.

When abrasive water jet-disc cutter combined TBM cutter head is breaking rock in practical engineering, for the set target kerf depth, a dominant parameter combination table of cutting performance can be obtained through the Equation (4) of the cutting depth prediction model of abrasive water jet. Under the parameter combinations derived from the cutting depth prediction model, the cutting performance of the abrasive water jet cutting hard rocks can be fully exerted, and practical engineering construction requirements can be considered to guide the high efficiency construction of the abrasive water jet-disc cutter combined TBM.

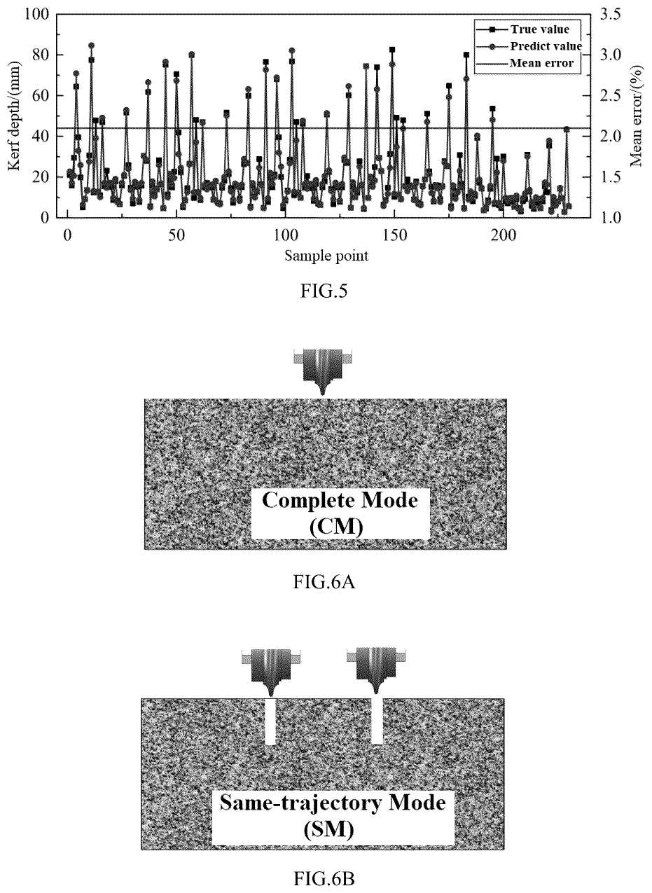

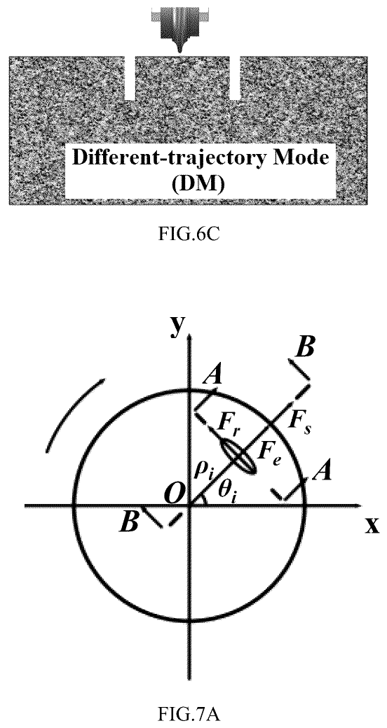

As shown in FIG. 6, based on the understanding of the layout structure of an abrasive water jet injection device and the TBM cutter head, when the abrasive water jet injection system is mounted on the TBM cutter head, there are mainly two combination modes of the same trajectory and different trajectories. Specifically, when an abrasive water jet nozzle is positioned directly in front of the disc cutter, it is defined as the same-trajectory rock-breaking mode (SM), and when the abrasive water jet nozzle is positioned on both sides of the disc cutter, it is defined as the different-trajectory rock-breaking mode (DM). To compare the rock-breaking performance of abrasive water jet assisted disc cutter, the complete cutting mode (CM) is defined when only disc cutter breaks the rocks.

Based on the combined cutting experiment, the relationship between kerf spacing distance (cutter spacing distance), penetration, kerf depth and rock-breaking performance under three modes is studied. The rock material is super-hard granite, and experiment parameters of combined rock-breaking experiment can be seen in Table 5. Finally, the rock-breaking characteristics of the three cutting modes are compared by using the rock-breaking force and specific energy for rock-breaking (Equation (5)) as evaluation indexes, so as to clarify the dominant parameters of the SM and DM and the applicable conditions of the combined rock-breaking mode.

$$SE = \frac{{\overline{F}}_{R} \times L}{M / ρ} ; \qquad ( 5 )$$

wherein, SE is the specific energy of rock-breaking, F̅_{R} is a rolling force, M is the mass of rock slag, ρ is the density of rock, and L is the cutting distance.

TABLE 5

| | | | | | Cutter | |
|---|---|---|---|---|---|---|
| | | Size of disc | Cutting | Kerf | spacing | Penetration |
| Cutting | Cutting | cutter/ | speed/ | depth/ | distance/ | depth/ |
| mode No. | mode name | (inch) | (mm/s) | (mm) | (mm) | (mm) |
| 1 | CM | 17 | 40 | 0 | 60, 70, 80, | 2, 3, 4, 6 |
| | | | | | 90 | |
| 2 | SM | | | 0, 6, 12, 18 | 60, 70, 80, | 2, 4, 6 |
| | | | | | 90 | |
| | | | | 0-0, 0-6, 6- | | |
| 3 | DM | | | 6, 6-12, 12- | 60, 70, 80, | 2, 4, 6 |
| | | | | 12, 12-18, | 90 | |
| | | | | 18-18 | | |

According to the results of the combined rock-breaking experiment, the selection criterions and optimal parameters of the combined rock-breaking mode can be obtained as shown in Table 6, and the combined rock-breaking mechanical model is established as shown in Equation (6).

TABLE 6

| Research | Experiment | Evaluation | Assessment result | |
|---|---|---|---|---|
| objective | condition | index | SM | DM |
| Trajectory | Kerf spacing | Normal | Excellent | Excellent |
| mode | distance/ | force | (Penetra- | (Penetra- |
| Applicability | (mm): 70 | | tion < kerf | tion ≥ kerf |
| | Penetration/ | | depth) | depth) |
| | (mm): 2-6 | | | |
| | Kerf depth/ | | | |
| | (mm): 6-18 | | | |
| Kerf spacing | Kerf spacing | Rock- | Optimal | Optimal |
| distance | distance/ | breaking | cutter | cutter |
| | (mm): 60-90 | force, | spacing | spacing |
| | Penetration/ | Specific | distance | distance |
| | (mm): 4 | energy for | is about | is about |
| | Kerf depth/ | rock- | 71 mm | 78 mm |
| | (mm): 18 | breaking | | |
| Penetration | Kerf spacing | Rock- | Optimal | Optimal |
| | distance/ | breaking | penetration | penetration |
| | (mm): 70 | force, | is about | is about |
| | Penetration/ | Specific | 4.9 mm | 3.8 mm |
| | (mm): 2-6 | energy for | | |
| | Kerf depth/ | rock- | | |
| | (mm): 6-18 | breaking | | |
| Kerf depth | Kerf spacing | Rock- | Optimal kerf depth | |
| | distance/ | breaking | is about 6 mm | |
| | (mm): 70 | force | | |
| | Penetration/ | | | |
| | (mm): 2-6 | | | |
| | Kerf depth/ | | | |
| | (mm): 6-18 | | | |

$${F}_{n}^{CM} = {F}_{t} cos ( \frac{ϕ}{2} ) = C {\frac{ϕ RW}{1 + ψ} [ \frac{S {σ}_{c}^{2} {σ}_{t}}{ϕ \sqrt{RW}} ]}^{\frac{1}{3}} cos ( \frac{ϕ}{2} ) \qquad ( 6 )$$

$${F}_{r}^{CM} = {F}_{t} sin ( \frac{ϕ}{2} ) = C {\frac{ϕ RW}{1 + ψ} [ \frac{S {σ}_{c}^{2} {σ}_{t}}{ϕ \sqrt{RW}} ]}^{\frac{1}{3}} sin ( \frac{ϕ}{2} )$$

$$\{ \begin{matrix}{F}_{n}^{SM} = [ {a}_{1} {e}^{- {b}_{1} H / {P}_{Penetration}} / {c}_{1} ] {F}_{n}^{CM} \\ {F}_{r}^{SM} = [ {a}_{2} {e}^{- {b}_{2} H / {P}_{Penetration}} / {c}_{2} ] {F}_{r}^{CM} \\ {a}_{1} = - 128.612 , {b}_{1} = 0.294 , {c}_{1} = - 129.078 \\ {a}_{2} = - 751.534 , {b}_{2} = 0.81 , {c}_{2} = - 764.88\end{matrix} ;$$

$$\{ \begin{matrix}{F}_{n}^{DM} = [ {a}_{1} {e}^{- {b}_{1} H / {P}_{Penetration}} / {c}_{1} ] {F}_{n}^{CM} \\ {F}_{r}^{DM} = [ {a}_{2} {e}^{- {b}_{2} H / {P}_{Penetration}} / {c}_{2} ] {F}_{r}^{CM} \\ {a}_{1} = 36.713 , {b}_{1} = 0.137 , {c}_{1} = 39.666 \\ {a}_{2} = 100.251 , {b}_{2} = 0.548 , {c}_{2} = 109.795\end{matrix}$$

wherein, Fₙ^{CM} and Fᵣ^{CM} are the rock-breaking force of the disc cutter in complete cutting mode calculated by a CSM model; Fₙ and Fᵣ are the normal force and the rolling force of the disc cutter in the combined rock-breaking; Pₚₑₙₑₜᵣₐₜᵢₒₙ is penetration, H is kerf depth; Fₜ is resultant force of the disc cutter; R is radius of disc cutter; W is edge width of the disc cutter; y is pressure distribution coefficient of cutting edge, which decreases with the increase of edge width, (−0.2˜0.2); ϕ is a contact angle between rock and the disc cutter; P⁰ is basic pressure; σ_{c} is uniaxial compressive strength of the rock; σₜ is tensile strength of the rock; S is the cutter spacing distance between the cutters, and C is constant which is about 2.12.

The rock-breaking process of the abrasive water jet-disc cutter combined TBM breaking rocks comprises two stages: a pre-cutting stage by the abrasive water jet and a rolling cutting stage by the disc cutter. In the pre-cutting stage, the abrasive water jet arranged in front of the disc cutter runs trajectory cuts cracks on rock surface in advance to reduce rock integrity. Then, the disc cutter rolls and cuts the tunnel face with pre-kerf to complete the whole process of combined rock-breaking. Therefore, the cutting parameters (pump pressure, target distance, traverse velocity and nozzle diameter) of the abrasive water jet, the rock-breaking parameters (penetration depth and cutter spacing distance) of the disc cutter and rock strength parameters will affect the rock-breaking performance of cutter head. At the same time, the TBM construction process will be subject to more random loads, resulting in extremely complex force state of the cutter head, and put forward strict requirements to the mechanical balance design of the cutter head. If the design is not reasonable, it will lead to premature failure of the cutter head, large bearings, disc cutter and etc., which will greatly affect the construction progress and benefits.

The layout principle of the cutter head is considered in the design, comprising: the requirement of cutting depth consistency of the abrasive water jet, the requirement of the geometric installation space of the water jet cutter, the requirement of the installation protection of the water jet cutter, the requirement of the mechanical balance of the combined cutter head, the requirement of the optimal rock-breaking efficiency, the requirement of the centroid distribution of the disc cutter, and the requirement of the rock breaking amount approaching of the disc cutter; according to the installation distribution characteristics of cutters on the cutter head, layout coordinates of the combined cutters on the cutter head are established; when the coordinates represent a position of the disc cutter on cutter head, the position of any the disc cutter can be expressed as Xᵢ(ρᵢ, θᵢ, αᵢ), wherein ρᵢ∈(0, ρₘₐₓ)θᵢ∈(0, 2π), αᵢ∈(0,π/2), which respectively are the installation polar radius, installation polar angle and inclination angle of the disc cutter, and expressing as

$$X = {⋃}_{i = 1}^{n} \{ {ρ}_{i} , {θ}_{i} , {α}_{i} \}$$

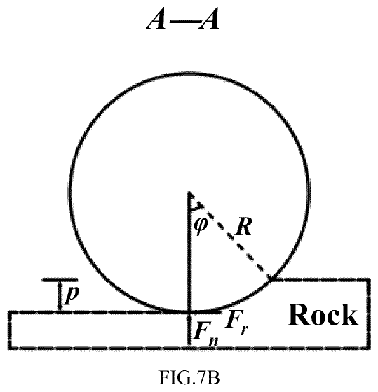

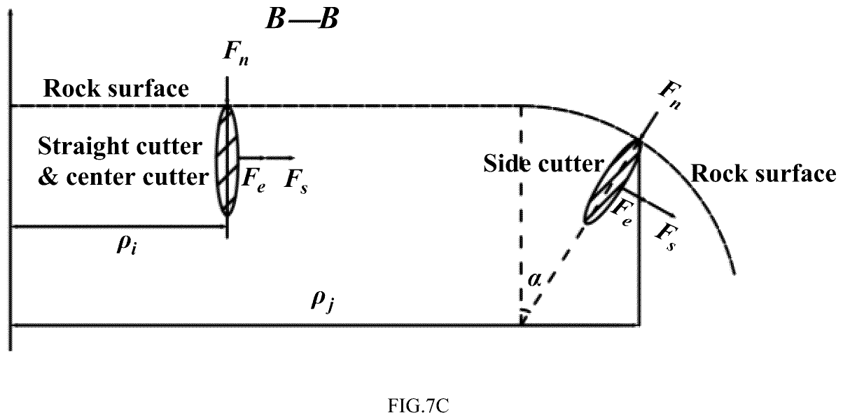

by using the installation polar radius variable, the installation polar angle variable and the inclination angle variable, as shown in FIG. 7.

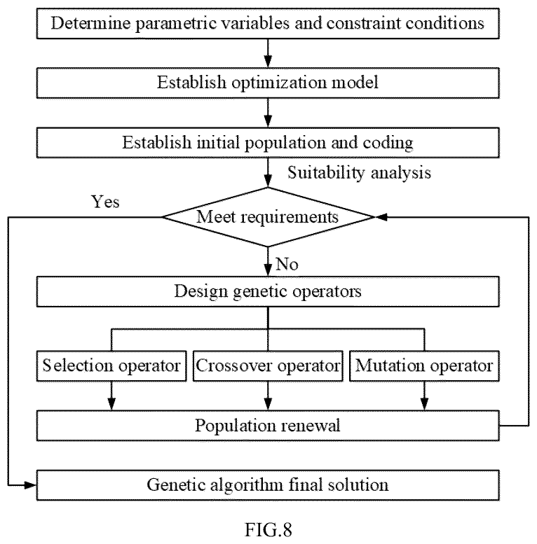

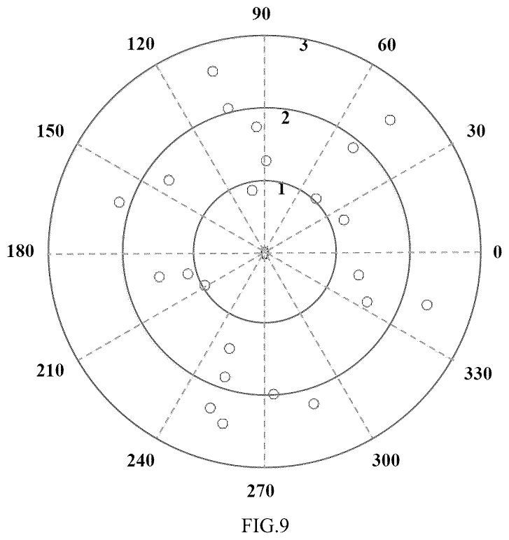

According to the layout principle of the cutter head in step 5, the radial resultant force of the cutter head, overturning moment, centroid distribution of the cutter head and rock-breaking amount difference of a single cutter are selected as optimization objective functions, optimal rock-breaking efficiency, optimal combination mode of water-jet nozzle and disc cutter, bearing capacity of single cutter and requirements of position noninterference are taken as constraint conditions to optimize the objective functions for modeling, a genetic algorithm (GA) is adopted to solve the objective functions, and the optimization sequence is overturning moment of cutter head, radial load, centroid distribution of cutter head and rock-breaking amount difference; then, GA is used to solve the layout coordinate of the cutters on the cutter head (as shown in FIG. 8), and artificial correction is carried out to complete the final design of combined cutter head. Wherein, a global optimization objective function of design optimization of the cutter head is:

$$min F ( X ) = ( {f}_{1} ( x ) , {f}_{2} ( x ) , {f}_{3} ( x ) , {f}_{4} ( x ) ) ;$$

The objective function of the radial resultant force of the cutter head is

$$\{ \begin{matrix}{F}_{x} = {\sum }_{i = 1}^{n} [ {F}_{ri} sin {θ}_{i} + ( {F}_{si} + {F}_{ei} ) cos {θ}_{i} ] \\ {F}_{y} = {\sum }_{i = 1}^{n} [ - {F}_{ri} cos {θ}_{i} + ( {F}_{si} + {F}_{ei} ) sin {θ}_{i} ] \\ {f}_{1} ( x ) : {F}_{XY} = \sqrt{{( {F}_{x} )}^{2} + {( {F}_{y} )}^{2}}\end{matrix} ;$$

wherein, Fᵣᵢ is the rolling force of the disc cutter when the i^{th} disc cutter is assisted by water jet to break rock, Fₛᵢ is the lateral force when the i^{th} disc cutter is assisted by water jet to break rock, Fₑᵢ is the centrifugal force of the i^{th} disc cutter, n is the total number of the disc cutter installed on the cutter head, Fₓ is the resultant force of all disc cutters in x-axis direction, F_{y} is the resultant force of all disc cutter in y-axis direction, and F_{XY} is a total radial resultant force of the cutter head.

The objective function of the overturning moment of the cutter head is:

$$\{ \begin{matrix}{M}_{x} = {\sum }_{i = 1}^{n} [ {M}_{i} sin {θ}_{i} + {F}_{ei} r sin {θ}_{i} - {F}_{ni} {ρ}_{i} sin {θ}_{i} ] \\ {M}_{y} = {\sum }_{i = 1}^{n} [ {M}_{i} cos {θ}_{i} + {F}_{ei} r cos {θ}_{i} - {F}_{ni} {ρ}_{i} cos {θ}_{i} ] \\ {f}_{2} ( x ) : {M}_{XY} = \sqrt{{( {M}_{x} )}^{2} + {( {M}_{y} )}^{2}}\end{matrix} ;$$

wherein, Fₙᵢ is the normal force of the i^{th} disc cutter, Fₑᵢ is the centrifugal force of the i^{th} disc cutter, Mᵢ is the co-inertia force of the i^{th} disc cutter, n is the total number of the disc cutter installed on the cutter head, Mₓ is the resultant moment of all disc cutters in x-axis direction, M_{y} is the resultant moment of all disc cutters in y-axis direction, and M_{XY} is the resultant moment of overturning of the cutter head.

The objective function of the centroid distribution of the cutter head is:

$$\{ \begin{matrix}{X}_{c} = \frac{{\sum }_{i = 1}^{n} {m}_{r} {σ}_{i} sin {θ}_{i}}{{m}_{r} n} = {\sum }_{i = 1}^{n} \frac{{ρ}_{i} sin {θ}_{i}}{n} \\ {Y}_{c} = \frac{{\sum }_{i = 1}^{n} {m}_{r} {σ}_{i} cos {θ}_{i}}{{m}_{r} n} = {\sum }_{i = 1}^{n} \frac{{ρ}_{i} cos {θ}_{i}}{n} \\ {f}_{3} ( x ) : {C}_{XY} = \frac{1}{n} \sqrt{{( {\sum }_{i = 1}^{n} {ρ}_{i} sin {θ}_{i} )}^{2} + {( {\sum }_{i = 1}^{n} {ρ}_{i} cos {θ}_{i} )}^{2}}\end{matrix} .$$

The objective function of rock breaking amount difference of the disc cutter is:

$${f}_{4} ( x ) : E ( χ ) = \sqrt{{\sum }_{i = 1}^{N} {( {V}_{i} - \overline{V} )}^{2}} ;$$

wherein, Vᵢ is the rock-breaking amount of the i^{th} disc cutter in one rotation of the disc cutter, and V̅ is the average rock-breaking volume of the n disc cutters on the cutter head.

The set requirement of the cutter spacing distance is expressed as:

$${g}_{1} ( X ) : 60 < S < 110 ,$$

$${g}_{3} ( X ) : 10 {P}_{penetration} < S < 20 {P}_{penetration} ;$$

wherein, S is the cutter spacing distance of the disc cutter, Pₚₑₙₑₜᵣₐₜᵢₒₙ is the penetration of the disc cutter.

The set requirement of installation position of the disc cutter is expressed as:

$${g}_{3} ( X ) = \vert {θ}_{i + 1} - {θ}_{i} \vert \geq \frac{ϕ}{ρ} ;$$

wherein, θᵢ and θᵢ₊₁ respectively represent an installation azimuth angle of adjacent the i^{th} disc cutter and the (i+1)^{th} disc cutter, ϕ is the diameter of the disc cutter and ρ is the installation pole diameter.

The set requirement of the load bearing capacity of the disc cutter is expressed as:

$${g}_{5} ( X ) = {F}_{ni} - {F}_{G} \leq 0 ;$$

wherein, Fₙᵢ is the normal rock-breaking force of the i^{th} disc cutter, and F_{G} is the rated bearing capacity of the disc cutter.

According to the above established design steps, principles and basis, the design optimization of positive disc cutter area of a cutter head used in a metro project is carried out. The size of the disc cutter used on the existing TBM cutter head is 17 inches, the cutter edge width is 17.5 mm, the weight is 160 kg, and the cutter edge pressure distribution coefficient is −0.2. The rotation speed of the cutter head is 6 rpm, the penetration depth of the cutter is only about 2 mm under the condition of 180 MPa ultra-hard rock formation, and the rock density is 2.62 g/cm³. A total of 43 disc cutters are installed on the TBM cutter head and the installation positions of the disc cutters as shown in Table 7.

TABLE 7

| | | | Cutter |
|---|---|---|---|
| | Polar | Polar | spacing |
| Cutter | radius/ | angle/ | distance/ |
| No. | (mm) | (°) | (mm) |
| 9 | 874 | 90 | 95 |
| 10 | 964 | 270 | 90 |
| 11 | 1049 | 135 | 85 |
| 12 | 1132 | 45 | 83 |
| 13 | 1212 | 315 | 80 |
| 14 | 1290 | 225 | 78 |
| 15 | 1368 | 0 | 78 |
| 16 | 1446 | 180 | 78 |
| 17 | 1524 | 45 | 78 |
| 18 | 1602 | 270 | 78 |
| 19 | 1680 | 135 | 78 |
| 20 | 1758 | 45 | 78 |
| 21 | 1836 | 315 | 78 |
| 22 | 1914 | 225 | 78 |
| 23 | 1992 | 0 | 78 |
| 24 | 2070 | 180 | 78 |
| 25 | 2148 | 90 | 78 |
| 26 | 2226 | 270 | 78 |
| 27 | 2304 | 135 | 78 |
| 28 | 2382 | 45 | 78 |
| 29 | 2460 | 315 | 78 |
| 30 | 2538 | 225 | 78 |
| 31 | 2616 | 345 | 78 |

Because of the great difference of cutting linear velocity of the disc cutter at different polar radius positions on the TBM cutter head, if the same abrasive water jet cutting parameters are used, there will inevitably be significant difference in kerf depth. In order to give full play to the auxiliary performance of the abrasive water jet and avoid overload failure of local disc cutter, the kerf depth of the abrasive water jet at different positions should be consistent as much as possible. By analyzing the pump pressure, the target distance and the nozzle diameter, it is found that the variation of the cutting depth can be improved by adjusting the specification (size) of the nozzle. On this basis, the rotation speed for the combined cutter head tunneling is selected as 4 rpm by synthesizing the construction parameters of TBM, the cutting performance of the abrasive water jet and the mechanical performance of combined rock-breaking. The cutting depth, when three 0.5 mm nozzles are arranged on the outermost positive disc cutter, is obtained to be 4.52 mm by using the cutting depth prediction model, and the penetration of disc cutter is set to be 4.5 mm. According to the selection principle of combined rock-breaking mode, the positive disc cutter of the cutter head should adopt the same-trajectory mode. The cutting parameters mentioned above are taken into the combined rock-breaking mechanical model, and when the penetration of the disc cutter is 4.5 mm, the rock-breaking force of the outermost disc cutter can meet the rated load requirement of the disc cutter. Further, the selection and the arrangement of the abrasive water jet nozzle at the corresponding position on inner side of the cutter head with the target of the kerf depth slightly greater than 4.5 mm are carried out. The results are shown in Table 8. In the range of rated load capacity of the disc cutter, comparing TBM tunneling speeds with and without abrasive water jet assistance, and the tunneling speed of the TBM with the abrasive water jet can be increased by about 50% in the range of abrasive water jet cutting optimal parameters. Optimization algorithm is used to optimize the overall coordination layout of the combined cutter head and the position parameters of the combined cutter head after optimization are shown in Table 9. As shown in FIG. 9, the performance of the optimized cutter head has been greatly improved. Specifically, the two main optimization objectives—the radial load and the cutter head overturning moment—are improved by 97.66% and 99.99% respectively after optimization, and the performance of the secondary optimization objective—centroid distance—is improved by 99.08%. The difference of rock-breaking amount is basically unchanged before and after the optimization, which verifies the feasibility of the optimization method.

TABLE 8

| | | | | | | Combined |
|---|---|---|---|---|---|---|
| | Polar | Specification | | Polar | Specification | rock- |
| Disc | radius/ | of nozzle/ | Disc | radius/ | of nozzle/ | breaking |
| cutter No. | (mm) | (mm)/unit | cutter No. | (mm) | (mm)/unit | mode |
| 9 | 874 | 0.30/2 | 21 | 1836 | 0.39/3 | SM |
| 10 | 964 | 0.32/2 | 22 | 1914 | 0.40/3 | |
| 11 | 1049 | 0.34/2 | 23 | 1992 | 0.42/3 | |
| 12 | 1132 | 0.37/2 | 24 | 2070 | 0.43/3 | |
| 13 | 1212 | 0.39/2 | 25 | 2148 | 0.44/3 | |
| 14 | 1290 | 0.40/2 | 26 | 2226 | 0.45/3 | |
| 15 | 1368 | 0.42/2 | 27 | 2304 | 0.46/3 | |
| 16 | 1446 | 0.44/2 | 28 | 2382 | 0.47/3 | |
| 17 | 1524 | 0.46/2 | 29 | 2460 | 0.48/3 | |
| 18 | 1602 | 0.48/2 | 30 | 2538 | 0.49/3 | |
| 19 | 1680 | 0.49/2 | 31 | 2616 | 0.50/3 | |
| 20 | 1758 | 0.37/3 | | | | |

TABLE 9

| | | | | | | Cutter |
|---|---|---|---|---|---|---|
| | Polar | Polar | | Polar | Polar | spacing |
| Disc | radius/ | angle/ | Disc | radius/ | angle/ | distance/ |
| cutter No. | (mm) | (°) | cutter No. | (mm) | (°) | (mm) |
| 9 | 0.874 | 101.48 | 21 | 1.822 | 252.31 | 79.18 |
| 10 | 0.953 | 209.01 | 22 | 1.901 | 49.64 | |
| 11 | 1.032 | 46.02 | 23 | 1.98 | 273.65 | |
| 12 | 1.111 | 195.84 | 24 | 2.059 | 104.32 | |
| 13 | 1.19 | 22.04 | 25 | 2.138 | 161.11 | |
| 14 | 1.269 | 89.04 | 26 | 2.217 | 287.94 | |
| 15 | 1.348 | 346.31 | 27 | 2.296 | 250.74 | |
| 16 | 1.427 | 249.93 | 28 | 2.375 | 342.00 | |
| 17 | 1.506 | 193.22 | 29 | 2.454 | 256.21 | |
| 18 | 1.585 | 334.07 | 30 | 2.533 | 46.41 | |
| 19 | 1.664 | 143.19 | 31 | 2.612 | 106.07 | |
| 20 | 1.743 | 93.71 | | | | |

### Example 2

The present invention provides a cutter head, being manufactured by using the method for designing the combined rock-breaking cutter head according to Example 1, and comprising:
S1: determining key parameters of cutting performance of abrasive water jet by taking a cutting depth of the abrasive water jet cutting rocks as a target, and determining dominant ranges of the key parameters of the abrasive water jet;
S2: classifying rock-breaking modes of abrasive water jet-disc cutter combined, and determining dominant ranges of rock-breaking parameters under different rock-breaking modes by considering a rock-breaking force and a rock-breaking energy dissipation of cutters;
S3: establishing a layout principle of a combined cutter head according to the dominant ranges of the key parameters and the dominant ranges of the rock-breaking parameters, and by considering a coordination and an installation distribution characteristics of multi-water jet cutter and multi-disc cutter combined rock-breaking on the combined cutter head;
S4: establishing optimization objective functions according to the layout principle of the combined cutter head, solving the optimization objective functions according to a preset optimization sequence under constraint conditions, and then obtaining optimized position parameters of the multi-water jet and the multi-disc cutter on a cutter head; and
S5: installing multiple water jets and multiple disc cutters at corresponding positions on the cutter head according to the obtained position parameters so as to obtain the combined cutter head.

The position parameters of the multiple water jets and the multiple disc cutters on the cutter head after the optimization are shown in Table 9, and a plane layout position of those cutters on the cutter head is shown in FIG. 9. The optimized combined cutter head can be obtained by installing the combined cutters at the corresponding positions on the combined cutter head according to Table 9 and FIG. 9, and the performance of the optimized cutter head is greatly improved. Specifically, the two main optimization objectives—the radial load and the cutter head overturning moment—are improved after the optimization, and the performance of the secondary optimization objective—centroid distance—is also improved. The difference of the rock-breaking amount is basically unchanged before and after optimization.

For a Union Jack pattern-shaped cutter head, a spiral linear cutter head or other types of cutter heads assisted by the abrasive water jet, after the disc cutter azimuth angle and installation pole radius are known, the combined rock-breaking mode, water jet nozzle selection and the combined rock-breaking can also be designed according to the research of the key technology of water jet rock-breaking and water jet-disc cutter combined rock-breaking, and the present example will not be described in detail.

It should be noted that the values of the parameters in the above examples are exemplary, and in other examples, they may be adjusted or changed according to other conditions such as rock conditions, which will not be repeated here again.

Although the specific embodiments of the present invention are described above in combination with the accompanying drawings, it is not a limitation on the protection scope of the present invention. Those skilled in the art should understand that on the basis of the technical scheme of the present invention, various modifications or deformations that can be made by those skilled in the art without creative labor are still within the protection scope of the present invention.

1. A method for designing an abrasive water jet-disc cutter combined rock-breaking cutter head, comprising the following steps:
determining key parameters of cutting performance of abrasive water jet by taking a cutting depth of the abrasive water jet cutting rocks as a target, and determining dominant ranges of the key parameters of the abrasive water jet;
classifying rock-breaking modes of abrasive water jet-disc cutter combined, and determining dominant ranges of rock-breaking parameters under different rock-breaking modes by considering a rock-breaking force and a rock-breaking energy dissipation of cutters;
establishing a layout principle of a combined cutter head according to the dominant ranges of the key parameters and the dominant ranges of the rock-breaking parameters, and by considering a coordination and an installation distribution characteristics of multi-water jet cutter and multi-disc cutter combined rock-breaking on the combined cutter head; and
establishing optimization objective functions according to the layout principle of the combined cutter head, solving the optimization objective functions according to a preset optimization sequence under constraint conditions, and then obtaining a final design scheme of the combined cutter head.

2. The method for designing the abrasive water jet-disc cutter combined rock-breaking cutter head according to claim 1, wherein the key parameters comprise a traverse velocity vₛ, a pump pressure P, a target distance h, cutting times T, a nozzle diameter d, and an abrasive flow rate mₐ.

3. The method for designing the abrasive water jet-disc cutter combined rock-breaking cutter head according to claim 2, wherein a rank of an importance of influence of process parameters of the abrasive water jet cutting rock on the cutting depth is
the traverse velocity vₛ>the cutting times T>the nozzle diameter d>the pump pressure P>the target distance h.

4. The method for designing the abrasive water jet-disc cutter combined rock-breaking cutter head according to claim 1, wherein the dominant ranges of the key parameters of the abrasive water jet comprises: the pump pressure P is of 280-350 MPa, the traverse velocity vₛ is of 0-15 m/min, the target distance h is of 15-40 mm, the abrasive flow rate mₐ is of 1150-1250 g/min, the nozzle diameter d is of 0.33-0.5 mm, and the cutting times T is of 1-3.

5. The method for designing the abrasive water jet-disc cutter combined rock-breaking cutter head according to claim 1, wherein a shearability index and an energy dissipation index are defined, wherein the shearability index is a ratio of a kerf depth of the abrasive water jet to the rock and corresponding parameter variable thereof, and the energy dissipation index is a ratio of a cutting energy dissipation of the abrasive water jet to the rock and the kerf depth; and, using the two indexes to analyze the key parameters which significantly affect the cutting performance of the abrasive water jet when the abrasive water jet breaks the rock and influence rules of each of the key parameters on the cutting performance of the abrasive water jet.

6. The method for designing the abrasive water jet-disc cutter combined rock-breaking cutter head according to claim 5, wherein the shearability index and the energy dissipation index comprise the following forms:
$${CI}_{P} = \frac{H}{P} , {CI}_{{v}_{s}} = \frac{H}{{v}_{s}} , {CI}_{h} = \frac{H}{h} , {CI}_{T} = \frac{H}{T} , {CI}_{d} = \frac{H}{d} , {CI}_{{m}_{a}} = \frac{H}{{m}_{a}} ;$$
$${v}_{water} = 44.7 \sqrt{P} , E = \frac{1}{2} {mv}_{water}^{2} = \frac{πρ {R}^{2} {L}_{displacement} {v}_{water}^{3}}{2 {v}_{s}} , EI = \frac{{mv}_{water}^{2}}{2 H} ;$$
wherein, CIₚ is the pump pressure shearability index, CIᵥ_{ₛ} is the traverse velocity shearability index, CIₕ is the target distance shearability index, CI_{T} is the cutting times shearability index, CI_{d} is the nozzle diameter shearability index, CIₘ_{ₐ} is the abrasive flow rate shearability index, EI is the cutting depth energy dissipation index, E is the energy dissipation, v_{water} is the abrasive water jet flow rate, vₛ is the traverse velocity, P is the pump pressure, T is the cutting times, d is the nozzle diameter, R is the nozzle radius, L_{displacement} is the cutting distance, H is the cutting depth, and h is the target distance.

7. The method for designing the abrasive water jet-disc cutter combined rock-breaking cutter head according to claim 1, wherein the abrasive water jet-disc cutter combined rock-breaking mode comprises: a same-trajectory rock-breaking mode and a different-trajectory rock-breaking mode, wherein the same-trajectory rock-breaking mode indicates that a cutting trajectory of the abrasive water jet on the combined cutter head overlaps with a cutting trajectory of a disc cutter, and the different-trajectory rock-breaking mode indicates that the cutting trajectories of the abrasive water jet and the disc cutter are different.

8. The method for designing the abrasive water jet-disc cutter combined rock-breaking cutter head according to claim 1, wherein by considering the rock-breaking force and rock-breaking energy dissipation of the cutters, a specific process of determining the dominant ranges of the rock-breaking parameters under the different rock-breaking modes comprises: respectively carrying out a performance evaluation of combined rock-breaking under multi-parameter conditions for the different rock-breaking modes; establishing a combined rock-breaking cutter mechanical model and selection criterions of a combined rock-breaking dominant mode with the rock-breaking force as evaluation indexes; and, determining dominant rock-breaking parameters of each the rock-breaking modes with the rock-breaking force and the rock-breaking energy dissipation as evaluation indexes.

9. The method for designing the abrasive water jet-disc cutter combined rock-breaking cutter head according to claim 8, wherein the combined rock-breaking cutter mechanical model is:
$${F}_{n}^{CM} = {F}_{t} cos ( \frac{ϕ}{2} ) = C {\frac{ϕ RW}{1 + ψ} [ \frac{S {σ}_{c}^{2} {σ}_{t}}{ϕ \sqrt{RW}} ]}^{\frac{1}{3}} cos ( \frac{ϕ}{2} ) ,$$
$${F}_{r}^{CM} = {F}_{t} sin ( \frac{ϕ}{2} ) = C {\frac{ϕ RW}{1 + ψ} [ \frac{S {σ}_{c}^{2} {σ}_{t}}{ϕ \sqrt{RW}} ]}^{\frac{1}{3}} sin ( \frac{ϕ}{2} ) ,$$
$$\{ \begin{matrix}{F}_{n}^{SM} = [ {a}_{1} {e}^{- {b}_{1} H / {P}_{Penetration}} / {c}_{1} ] {F}_{n}^{CM} \\ {F}_{r}^{SM} = [ {a}_{2} {e}^{- {b}_{2} H / {P}_{Penetration}} / {c}_{2} ] {F}_{r}^{CM} \\ {F}_{n}^{DM} = [ {a}_{1} {e}^{- {b}_{1} H / {P}_{Penetration}} / {c}_{1} ] {F}_{n}^{CM} \\ {F}_{r}^{DM} = [ {a}_{2} {e}^{- {b}_{2} H / {P}_{Penetration}} / {c}_{2} ] {F}_{r}^{CM}\end{matrix} ;$$
wherein,
$${F}_{n}^{CM} and {F}_{r}^{CM}$$
are rock-breaking forces of a disc cutter in complete cutting mode calculated by a CSM model (C indicates “Critical Path Method”, S indicates “Schedule Quantification Method”, and M indicates “Monte Carlo Simulation”); Fₙ and Fᵣ are a normal force and a rolling force of the disc cutter in the combined rock-breaking, Pₚₑₙₑₜᵣₐₜᵢₒₙ is penetration, H is kerf depth, Fₜ is resultant force of the disc cutter, R is radius of disc cutter, W is edge width of the disc cutter, ψ is pressure distribution coefficient of cutting edge, which decreases with the increase of edge width, ϕ is a contact angle between rock and the disc cutter, P⁰ is basic pressure, σ_{c} is uniaxial compressive strength of the rock, σₜ is tensile strength of the rock, S is a cutter spacing distance between the cutters, C is constant, aᵢ and cᵢ are coefficients respectively, wherein i=1 or 2.

10. The method for designing the abrasive water jet-disc cutter combined rock-breaking cutter head according to claim 1, wherein the selection criterions of the combined rock-breaking dominant mode is:
when a penetration of a disc cutter<a kerf depth, a same-trajectory rock-breaking mode is optimal; and
when the penetration of the disc cutter≥the kerf depth, a different-trajectory rock-breaking mode is optimal.

11. The method for designing the abrasive water jet-disc cutter combined rock-breaking cutter head according to claim 1, wherein the dominant rock-breaking parameters comprise: a cutter spacing distance, a penetration of disc cutter and a kerf depth.

12. The method for designing the abrasive water jet-disc cutter combined rock-breaking cutter head according to claim 1, wherein the layout principle on the combined cutter head comprises a plurality of requirements, such as requirement of cutting depth consistency of the abrasive water jet, requirement of geometric installation space requirement of the water jet, requirement of installation protection requirement of the water jet, requirement of mechanical balance of the combined cutter head, requirement of optimal rock-breaking efficiency, requirement of centroid distribution of the disc cutter, and requirement of rock-breaking amount approaching of the disc cutter.

13. The method for designing the abrasive water jet-disc cutter combined rock-breaking cutter head according to claim 1, wherein the optimization objective functions comprise a cutter head radial resultant force, an overturning moment, a cutter head centroid distribution and a rock-breaking amount difference of single cutter.

14. The method for designing the abrasive water jet-disc cutter combined rock-breaking cutter head according to claim 1, wherein the constraint conditions comprise several of optimal rock-breaking efficiency, optimal combination mode of the water jet and the disc cutter, single-cutter bearing capacity and position non-interference requirement.

15. The method for designing the abrasive water jet-disc cutter combined rock-breaking cutter head according to claim 1, wherein the preset optimization sequence comprises a cutter head overturning moment, a radial load, a cutter head centroid distribution and a rock-breaking amount difference.

16. A system for designing an abrasive water jet-disc cutter combined rock-breaking cutter head, comprising:
an abrasive water jet analysis module, configured to determine key parameters of cutting performance of abrasive water jet and determine dominant ranges of the key parameters of the abrasive water jet with a cutting depth of the abrasive water jet cutting rock as a target;
a combined rock-breaking analysis module, configured to classify abrasive water jet-disc cutter combined rock-breaking modes, and determine dominant ranges of rock-breaking parameters under different modes by considering a rock-breaking force and a rock-breaking energy dissipation of cutters;
a cutter head layout principle determining module, configured to establish a cutter head layout principle by comprehensively considering coordination and installation distribution characteristics of a combined cutter head with multi-water jet and multi-disc cutter combined rock-breaking according to the dominant ranges of the key parameters and the dominant ranges of the rock-breaking parameters; and
an optimization solution module, configured to establish optimization objective functions according to the cutter head layout principle, and solve the optimization objective functions according to a predetermined optimization sequence under constraint conditions to obtain a final design scheme of the combined cutter head.

17. A cutter head, being obtained by the method according to claim 1.

18. A tunnel boring machine (TBM), comprising the cutter head according to claim 17.

19. The method for designing the abrasive water jet-disc cutter combined rock-breaking cutter head according to claim 8, wherein the selection criterions of the combined rock-breaking dominant mode is:
when a penetration of a disc cutter<a kerf depth, a same-trajectory rock-breaking mode is optimal; and
when the penetration of the disc cutter≥the kerf depth, a different-trajectory rock-breaking mode is optimal.

20. The method for designing the abrasive water jet-disc cutter combined rock-breaking cutter head according to claim 8, wherein the dominant rock-breaking parameters comprise: a cutter spacing distance, a penetration of disc cutter and a kerf depth.
